(19) United States
(12) Patent Application Publication
(10) Pub. No.: US 2024/0280206 A1
(43) Pub. Date: Aug. 22, 2024

(54) ASSEMBLY AND METHOD FOR REPAIRING PIPE HAVING MORE COMPLETE LINER EXPANSION

(71) Applicant: MORAY GROUP, LLC, ELK GROVE VILLAGE, IL (US)

(72) Inventors: CHRIS RAS, ELK GROVE VILLAGE, IL (US); DAVID RIDGE, ELK GROVE VILLAGE, IL (US)

(73) Assignee: MORAY GROUP, LLC, ELK GROVE VILLAGE, IL (US)

(21) Appl. No.: 18/444,907

(22) Filed: Feb. 19, 2024

Related U.S. Application Data
(60) Provisional application No. 63/485,744, filed on Feb. 17, 2023.

(51) Int. Cl. F16L 55/165

(52) U.S. Cl. CPC F16L 55/1656; F16L 55/1654

(57) ABSTRACT

An assembly and method for repairing a pipeline. The assembly may include a sleeve positioned between a bladder and a liner. The sleeve includes a relief area having a reduced modulus of elasticity. The reduced modulus of elasticity at the relief area allows the sleeve to expand outward with less pressure. Upon the introduction of fluid pressure into the bladder, the bladder, sleeve, and liner expand outward at the relief area first. Then, as pressure inside the bladder increases, the remainder of the assembly is expanded. In this manner the user can control which area of the assembly is expanded first by positioning the relief area at the appropriate location. In another embodiment a semi-rigid member is wound around the outside of the liner in a helical configuration to provide a pathway for trapped air to escape during inflation of the bladder and curing of the liner.

This application is based upon U.S. Provisional Application Ser. No. 63/485,744 filed Feb. 17, 2023, the complete disclosure of which is hereby expressly incorporated by this reference.

### BACKGROUND

The present invention relates to a device and method for repairing pipe, such as underground sewer pipe and the like. Prior methods for repairing damaged pipelines include moving a liner impregnated with a liquid material capable of curing and hardening to the position within the pipe where the damaged portion is located. The liner is urged in an outward radial direction into contact with the pipeline being repaired and the liquid material impregnating the liner tube is permitted to cure and harden. The liner forms an interior liner in the pipe for the pipeline being repaired.

One existing method for repairing pipelines and other structures includes the use of a liner having a felt layer on its inside and having a protective layer made of polymer or other plastic material on its outside. The liner tube is vacuum-impregnated with a resin mix in what is commonly referred to as a “wet-out” process. Just prior to wetting-out the liner, a catalyst is mixed with the resin so as to activate the resin and cause it to begin curing and hardening. The resin impregnated liner is then positioned in the pipeline and an expandable bladder is inflated to urge the liner outward into contact with the inner wall of the damaged pipe. Once the resin cures and hardens, the liner provides a new lining for the pipeline. Some resins are set to cure at ambient temperatures. In recent years the industry has begun impregnating the liner with light-activated resin, then shining ultra violet (UV) (or other suitable wavelength) light toward the liner to begin the curing process after the liner is placed within the pipeline. Light-activated resins help overcome certain drawbacks in other types of resins because the resin in the impregnated liner does not begin to cure until it is exposed to the UV light.

One problem with existing repair systems is that fluid such as water or air can get stuck between the liner and the pipe wall, especially at pipe bends or elbows. The bladder fully inflates and presses the liner against the pipe wall on either side of the bend leaving an air pocket between the liner and the pipe at the bend. The air cannot escape either direction since the liner has already sealed against the pipe at the ends, so the bladder inflates the liner against the air pocket instead of fully inflating the liner against the wall of the pipe. This decreases the internal diameter of the liner which can lead to flow problems and restrictions through the newly lined pipe.

Therefore, there is a need for an improved method and assembly for repairing pipes which overcomes these and other problems in the art.

### SUMMARY

According to one aspect of the present invention, a sleeve is provided for repairing a pipeline. The sleeve is configured to be used with a repair assembly. The repair assembly includes the sleeve positioned between a bladder and a liner. The sleeve has a first portion and a second portion. The first portion has a first modulus of elasticity and the second portion includes a relief area having a second modulus of elasticity that is less than the first modulus of elasticity. The reduced modulus of elasticity of the relief area may be created by having the relief area be a different or thinner material than other areas of the sleeve or by having one or more openings (punctures, cuts, or slits) in the sleeve. The relief area openings may extend all the way through the sleeve or they may only extend partially through the sleeve. The relief area may extend longitudinally along the length of the sleeve a predetermined distance, such as the length of the liner or the length of a bend in the pipe. The reduced modulus of elasticity at the relief area allows the sleeve to expand outward with less pressure. Conversely, more pressure is required to expand the sleeve along the portions of the sleeve without the relief area. Therefore, upon the introduction of fluid pressure into the bladder, the bladder, sleeve, and liner expand outward at the relief area first. Then, as pressure inside the bladder increases, the remainder of the assembly is expanded. In this manner the user can control which area of the assembly is expanded first by positioning the relief area at the appropriate location.

According to another aspect of the present invention, an assembly is provided for repairing a pipeline. The assembly is configured to be positioned in the pipeline by any suitable means, including by pushing or pulling the assembly into the pipeline as part of a packer. The assembly includes a sleeve positioned between a bladder and a liner. The bladder is a fluid sealed bladder capable of expanding upon introducing a fluid, such as air, into the bladder. The bladder may be part of the packer. The bladder and sleeve are made from an expandable material and the sleeve may be made from the same material as the bladder. The bladder is positioned radially inward of the sleeve and the liner is positioned radially outward of the sleeve, however, the components do not necessarily need to be adjacent to each other. The liner is configured to be impregnated with a resin capable of curing and hardening. The sleeve includes a relief area having a reduced modulus of elasticity. The reduced modulus of elasticity of the relief area may be created by having the relief area be a different or thinner material than other areas of the sleeve or by having one or more openings (punctures, cuts, or slits) in the sleeve. The relief area openings may extend all the way through the sleeve or they may only extend partially through the sleeve. The relief area may extend longitudinally along the length of the sleeve a predetermined distance, such as the length of the liner or the length of a bend in the pipe. The reduced modulus of elasticity at the relief area allows the sleeve to expand outward with less pressure. Conversely, more pressure is required to expand the sleeve along the portions of the sleeve without the relief area. Therefore, upon the introduction of fluid pressure into the bladder, the bladder, sleeve, and liner expand outward at the relief area first. Then, as pressure inside the bladder increases, the remainder of the assembly is expanded. In this manner the user can control which area of the assembly is expanded first by positioning the relief area at the appropriate location. In some embodiments the relief area is positioned near the center of the liner so expansion of the repair assembly begins near the middle and extends outward, pushing air from the center outward toward the ends of the assembly.

Another aspect of the present invention includes a method of making and using the assembly described above for repairing a pipeline. The method includes creating a relief area in the sleeve having a reduced modulus of elasticity by making a portion of the sleeve with a different (more elastic) material, a thinner cross section, or an opening by puncturing, cutting, or slicing a portion of the sleeve. Then, positioning the sleeve over the bladder. Impregnating the liner with a resin capable of curing and hardening, then positioning the liner over the sleeve. Positioning the assembly in the pipe at a damaged portion needing repair, then inflating the bladder using fluid pressure causing the assembly to expand outward toward the inside wall of the pipe. In some embodiments the assembly is positioned in the pipe so the relief area is positioned within a bend or curve in the pipe. The relief area having the reduced modulus of elasticity expands first causing the bladder to urge the liner toward at the pipe at the relief area location, but not at other locations along the length of the assembly. Additional fluid pressure is introduced into the bladder to expand the assembly until the remaining portions of the assembly are properly inflated and positioned. After the liner has cured and hardened, removing the packer, bladder, and sleeve from the pipe.

Another aspect of the present invention includes a semi-rigid member for repairing a pipeline. The semi-rigid member is configured to be used with a repair assembly. The repair assembly includes a bladder and a liner, and the semi-rigid member is configured to be positioned around the outer surface of the liner. The semi-rigid member may be compressible; however, it is rigid enough to maintain some shape upon the application of pressure. The semi-rigid member may be made from a hydrophilic or hydrophobic material. The semi-rigid member may be wound around the liner in a helical configuration. The semi-rigid member may be an O-ring.

Another aspect of the present invention includes an assembly for repairing a pipeline. The assembly is configured to be positioned in the pipeline by any suitable means, including by pushing or pulling the assembly into the pipeline as part of a packer. The assembly includes a bladder and a liner. The bladder is a fluid sealed bladder capable of expanding upon introducing a fluid, such as air, into the bladder. The bladder may be part of the packer. The liner is configured to be impregnated with a resin capable of curing and hardening. A semi-rigid member is positioned along the outside of the liner. The semi-rigid member may be compressible; however, it is rigid enough to maintain some shape upon the application of pressure. The semi-rigid member may be made from a hydrophilic or hydrophobic material. The semi-rigid member may be wound around the liner in a helical configuration. The semi-rigid member may be an O-ring.

Another aspect of the invention includes a method of using the assembly described in the previous paragraph. The method includes preparing the assembly by impregnating the liner with a resin capable of curing and hardening, then positioning the liner over the bladder. A semi-rigid member is then positioned along the outside surface of the liner. In some embodiments, the semi-rigid member may be wrapped around the liner in a helical configuration. Positioning the assembly in the pipe at a damaged portion needing repair, then inflating the bladder using fluid pressure causing the assembly to expand outward toward the inside wall of the pipe. In some embodiments the assembly is positioned in the pipe so a portion of the liner is at a bend or curve in the pipe. The semi-rigid member provides a gap or pathway between the liner and the inner wall of the pipe. Any air trapped between the liner and the pipe wall will travel along the pathway created by the semi-rigid member to an end of the liner. In this manner, pockets of air cannot get trapped between the liner and the pipe wall and the liner is able to expand outward to the pipe wall, even at bends or curves in the pipe.

### BRIEF DESCRIPTION OF THE DRAWINGS

FIG. 1 is a perspective view of a sleeve having a relief area.

FIG. 2 is a side view of a repair assembly having a relief area where the liner is not yet wrapped around the assembly.

FIG. 3 is a section view of the repair assembly shown in FIG. 2 before inflation.

FIG. 4 is a section view of the repair assembly shown in FIG. 2 partially inflated.

FIG. 4A is a section view of the repair assembly shown in FIG. 2 fully inflated.

FIG. 5 is a section view of the repair assembly of FIG. 2 where the relief area is positioned at a pipe bend.

FIG. 6 is a section view similar to FIG. 5 but showing the repair assembly partially inflated.

FIG. 7 is a section view similar to FIG. 5 but showing the repair assembly fully inflated.

FIG. 8 is a side view of a repair assembly having a semi-rigid member wrapped around the liner.

FIG. 9 is a section view of the repair assembly shown in FIG. 8 before inflation.

FIG. 10 is a section view of the repair assembly of FIG. 8 positioned in at a pipe bend before inflation.

FIG. 11 is a section view similar to FIG. 10 but showing the repair assembly fully inflated.

FIG. 12 is a section view of an exemplary semi-rigid member.

### DETAILED DESCRIPTION

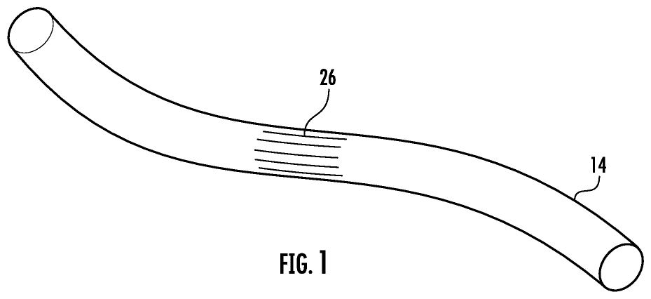

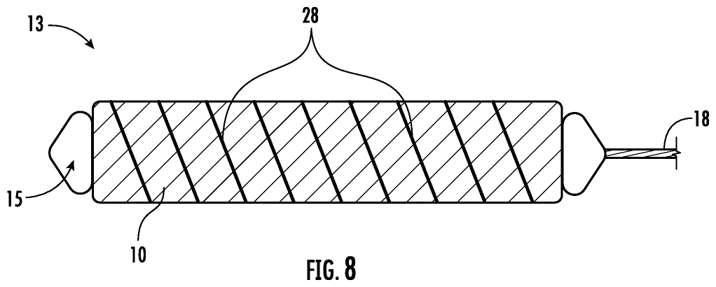

The invention generally relates to assemblies and methods for repairing a pipeline 11. The repair assembly 13 is configured to be positioned in the pipeline 11 by any suitable means, including by pushing or pulling the assembly 13 into the pipeline 11. FIGS. 1-7 show a first embodiment and FIGS. 8-12 show a second embodiment. The features of the embodiments may be used alone or together in a single repair assembly 13.

The sleeve 14 of the first embodiment is configured to be used with a repair assembly 13. The sleeve 14 is configured to be positioned between a bladder 12 and a liner 10. FIG. 1 shows the sleeve 14 apart from the rest of the repair assembly 13. The sleeve 14 includes a relief area 26 having a reduced modulus of elasticity. In other words, the relief area 26 is more elastic and stretches easier than other areas of the sleeve 14. In some embodiments the relief area 26 is between other areas of the sleeve 14 having a higher modulus of elasticity. The reduced modulus of elasticity of the relief area 26 may be created by any suitable means and typically extends around the outer circumference of the sleeve 14. In some embodiments the reduced modulus of elasticity is created at the relief area by having the relief area 26 be thinner than other areas of the sleeve 14. In some embodiments the reduced modulus of elasticity is created at the relief area 26 by making the relief area 26 from a different (more elastic/flexible) material than other areas of the sleeve 14. In some embodiments the reduced modulus of elasticity is created at the relief area 26 by having one or more openings (punctures, cuts, slits, or other areas where material is removed from the sleeve 14) in the sleeve 14 at the relief area 26. The openings may extend all the way through the sleeve 14 or they may only extend only partially through the sleeve 14.

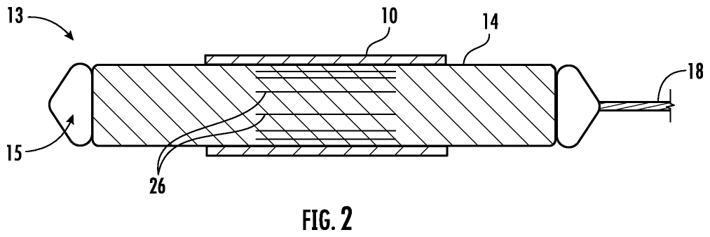

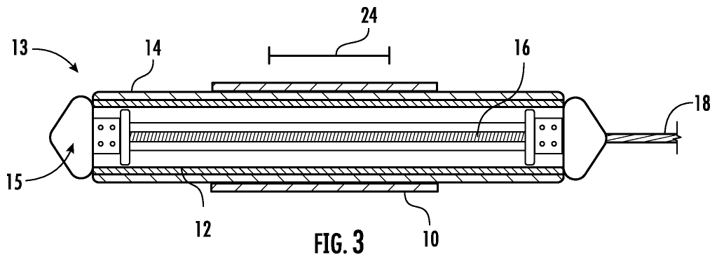

FIGS. 1 and 2 show the relief area 26 as being a plurality of slits cut longitudinally in the sleeve 14 around the outer circumference of the sleeve 14. The relief area 26 may extend longitudinally along the length of the sleeve 14 a predetermined distance, such as the length of the liner 10 or the length of a bend in the pipe. The length of the relief area is designated by reference number 24 in FIGS. 3-7.

FIGS. 3-7 are section views showing the other components of the repair assembly 13. The bladder 12 is a fluid sealed bladder 12 capable of expanding upon introducing a fluid, such as air, into the bladder 12. Fluid (such as air pressure) may be introduced into the bladder 16 through tube 18, which may also be used to position (push/pull) the repair assembly 13 in the pipe 11 and communicate power to the lighting assembly 16. The bladder 12 may be part of the packer 15. The bladder 12 and sleeve 14 are made from an expandable material and the sleeve 14 may be made from the same material as the bladder 12. The bladder 12 is positioned radially inward of the sleeve 14 and the liner 10 is positioned radially outward of the sleeve 14, however, the components do not necessarily need to be adjacent to each other.

The liner 10 is configured to be impregnated with a resin capable of curing and hardening. The liner 10 is comprised of a felt layer, which is the lining surface that contacts the interior surface of the host pipe, and a polymer coating is on the opposite surface. The felt layer of the liner 10 is configured to be impregnated with the curable resin. The liner 10 may be comprised of what is initially a flat sheet of material wrapped around the outside of the bladder 12. The liner 10 may include overlapping edges to form a tube.

In some embodiments the resin is a light-activated resin having light-activated initiators embodied therein and the assembly further includes a lighting assembly 16 positioned within the bladder 12. The one or more light-activated initiators are set to begin curing the resin upon exposure to one or more predetermined wavelengths of light generated by the lighting assembly 16. The one or more wavelengths could be ultra-violate (UV), infrared (IR), violet or blue light (near the end of the visible spectrum), or any other suitable wavelength. In embodiments using light-curing, the bladder 12 and sleeve 14 are made from a light-permeable material which allows one or more wavelengths of light to pass through to the light-activated initiators impregnated in the liner 10. The bladder 12 and sleeve 14 material need not be translucent or transparent as long as the wavelength(s) of light which triggers the light-activated initiator is allowed to pass through. In some embodiments the bladder material allows a first wavelength such as UV to pass through but prevents a second wavelength such as visible light from passing through. Selectively allowing only certain wavelengths of light to pass through the bladder 12 and sleeve 14 help ensure curing is only initiated at the proper time.

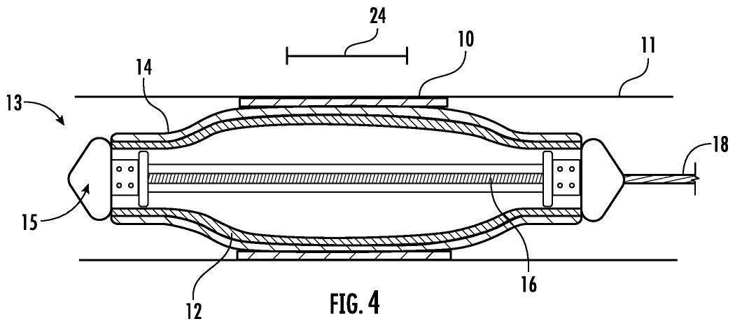

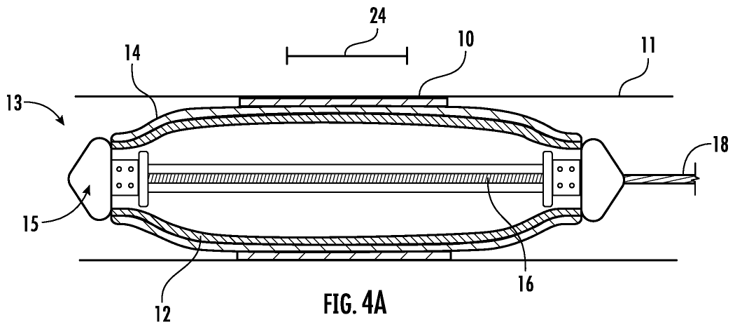

FIG. 3 shows the repair assembly 13 before inflation. As noted above, the length and position of the relief area 26 is designated by reference number 24 since the surface of the sleeve 14 is not easily visible in the section views. FIG. 4 shows the repair assembly 13 positioned within a pipe 11 wherein the assembly 13 is partially inflated. The reduced modulus of elasticity at the relief area 26 allows the sleeve 14 to expand outward with less pressure. Conversely, more pressure is required to expand the sleeve 14 along the portions of the sleeve 14 without the relief area 26. Therefore, upon the introduction of fluid pressure into the bladder 12, the bladder 12, sleeve 14, and liner 10 expand outward at the relief area 26 first. Then, as pressure inside the bladder 12 increases due to the continued introduction of fluid, the remainder of the bladder 12, sleeve 14, and liner 10 are expanded. In this manner the user can control which area of the assembly is expanded first. As shown in FIGS. 4 and 4A, expanding the assembly 13 near its center before expanding the ends helps to minimize fluid (water or air) pockets trapped between the liner 10 and the pipe 11. In other words, any fluid between the liner 10 and the pipe 11 will be pushed outward toward an end of the assembly 13 as the assembly 13 expands first at its center then toward its ends.

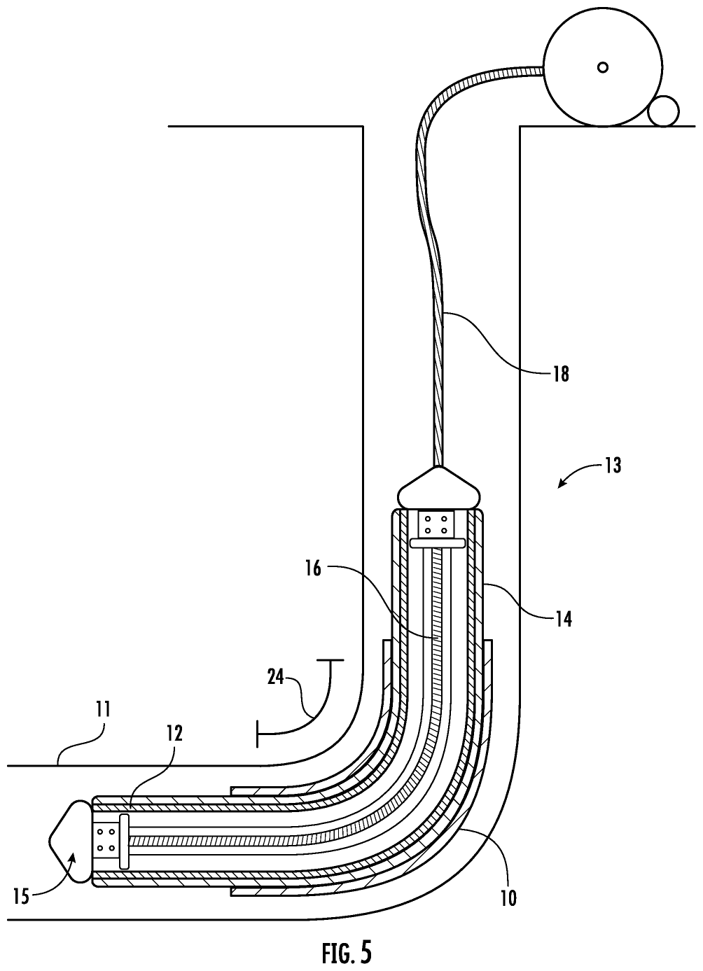

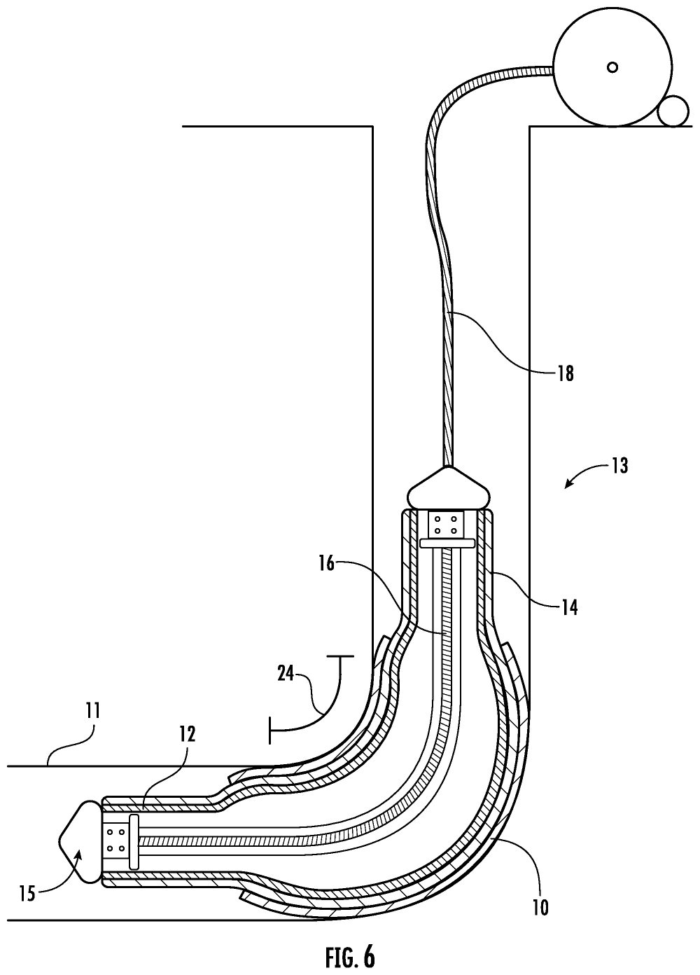

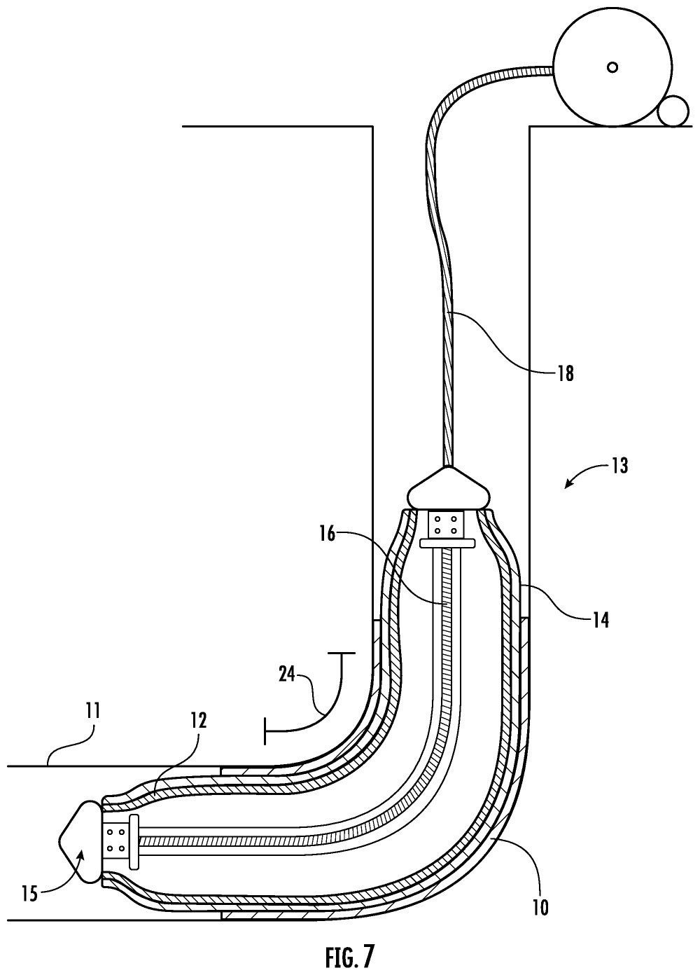

FIGS. 5-7 show the repair assembly 13 positioned at a bend in the pipeline 11. The relief area 26 is positioned at the bend in the pipeline 11 so the components expand there first. This helps to ensure the liner 10 expands outward toward the pipe 11 at the bend before the ends of the assembly 13 expand outward toward the pipe 11. Expanding the assembly 13 at the bend before expanding on either side of the bend helps to minimize fluid (water or air) pockets trapped between the liner 10 and the pipe 11 at the bend. In other words, any fluid between the liner 10 and the pipe 11 will be pushed outward toward an end of the assembly 13 as the assembly 13 expands first at the bend then toward its ends. FIG. 5 shows the repair assembly 13 before inflation, FIG. 6 shows the repair assembly partially inflated, and FIG. 7 shows the repair assembly fully inflated.

In use, a relief area 26 having a reduced modulus of elasticity in created in the sleeve 14 by making a portion of the sleeve 14 with a more elastic material, a thinner cross section, or by creating openings in a portion of the sleeve 14. Then, positioning the sleeve 14 over the bladder 12. Impregnating the liner 10 with a resin capable of curing and hardening, then positioning the liner 10 over the sleeve 14. Positioning the assembly in the pipe at a damaged portion needing repair, then inflating the bladder 12 using fluid pressure causing the assembly to expand outward toward the inside wall of the pipe. In some embodiments the assembly is positioned in the pipe so the relief area 26 is positioned within a bend or curve in the pipe. The relief area 26 having the reduced modulus of elasticity expanding first causing the bladder 12 to urge the liner 10 toward at the pipe at the relief area 26 location 24. Any air or fluid between the liner 10 and the pipe 11 is conveyed from the relief area 26 location 24 outward toward the ends of the assembly 13 instead of becoming trapped between the liner 10 and the pipe 11. Continuing to expand the assembly until the remaining portions of the assembly 13 are properly positioned. In some embodiments the assembly can be used to move fluid, such as water, to another location. For example, the relief area 26 may be positioned at an end of the assembly. Upon inflation the assembly expands toward the inner pipe wall at the relief area 26 first, then expands serially away from the relief area 26. In this manner the assembly can be used to convey or squeegee water between the pipe wall and the serially expanding assembly from a first location to a second location. After the liner 10 has cured and hardened, removing the packer, bladder 12, and sleeve 14 from the pipe.

Another embodiment of the invention is shown in FIGS. 8-12 wherein a semi-rigid member 28 is configured to be used with a repair assembly 13 for repairing a pipeline 11. Many components of the repair assembly 13 of this embodiment are similar to those same elements described above, including the liner 10 and bladder 16. Further, some embodiments of the second embodiment include the lighting assembly 16, as described above. The features of this embodiment may be used alone or they may be used with the features described in the preceding embodiment in a single repair assembly 13.

The repair assembly 13 generally includes a bladder 12 and a liner 10. As described above, the bladder 12 is a fluid sealed bladder 12 capable of expanding upon introducing a fluid, such as air, into the bladder 12. The bladder 12 may be part of the packer 15. The liner 10 is configured to be impregnated with a resin capable of curing and hardening.

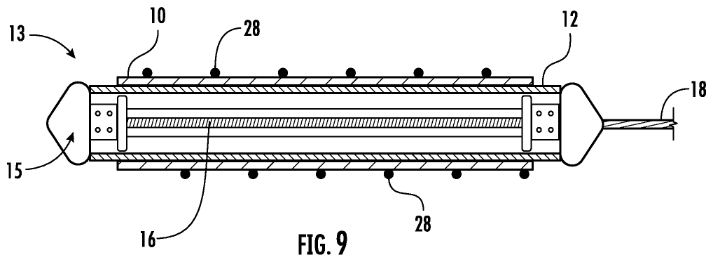

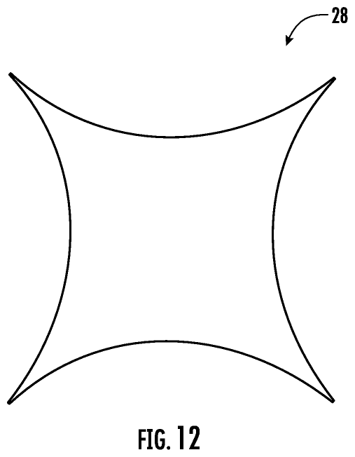

As shown in FIGS. 8 and 9, a semi-rigid member 28 is positioned along the outside of the liner 10. The semi-rigid member 28 may be compressible; however, it is rigid enough to maintain some shape upon the application of pressure. The semi-rigid member 28 is stretchable so that is stretches as the bladder 12 urges the liner 10 outward toward the inner wall of the pipe 11. The semi-rigid member 28 may be made from a hydrophilic or hydrophobic material. In some embodiments the semi-rigid member 28 is positioned along the outer surface of the liner 10 in a generally longitudinal direction. As shown in FIG. 8, in other embodiments the semi-rigid member 28 is wound around the liner 10 in a helical configuration. In some embodiments the semi-rigid member 28 is an O-ring. In some embodiments the semi-rigid member 28 is an “X” shaped O-ring as shown in FIG. 12. The “X” shape of the semi-rigid member 28 has one or more concave surfaces which help provide a pathway for the fluid to travel along the length of the semi-rigid member 28.

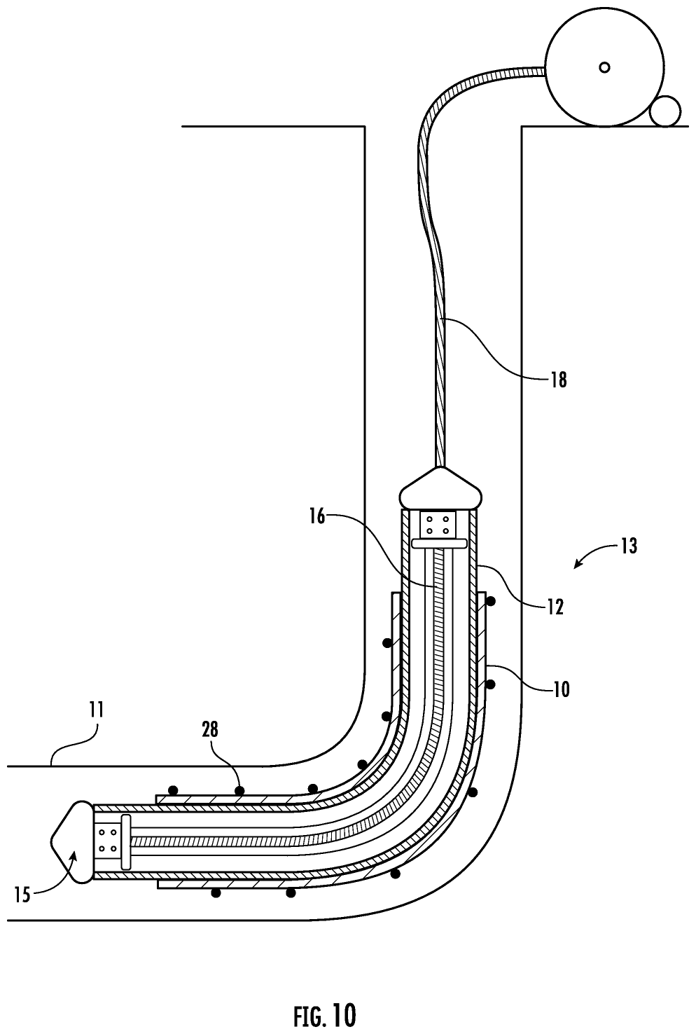

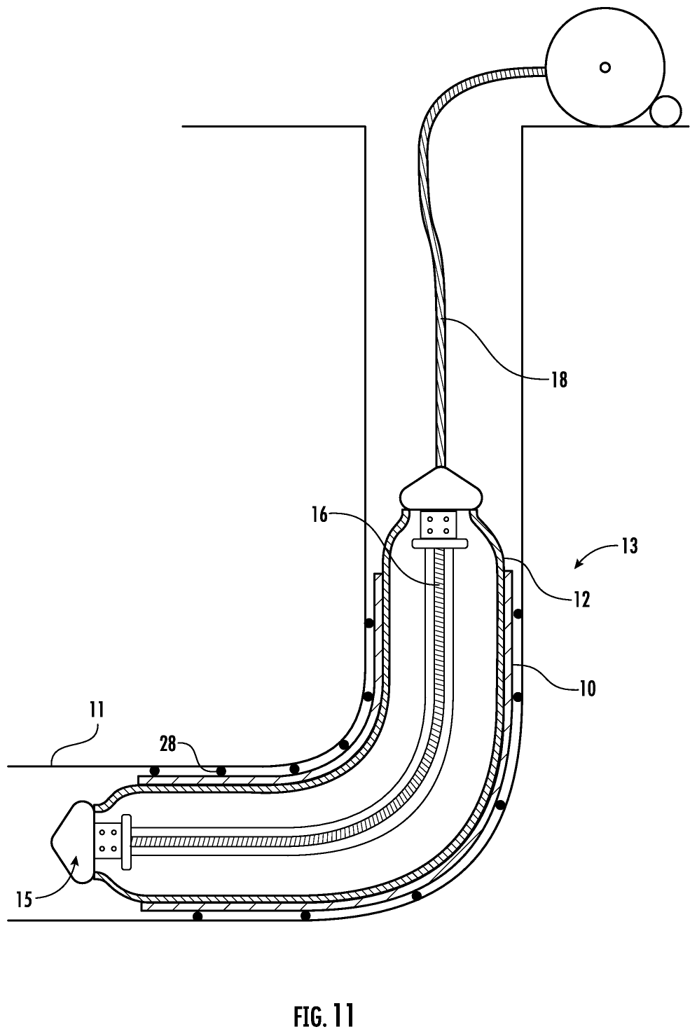

FIGS. 10 and 11 show the repair assembly 13 positioned at a bend in the pipe 11 wherein FIG. 10 shows the repair assembly 13 before inflation and FIG. 11 shows the repair assembly after inflation. In use, after the repair assembly 13 is positioned within the pipe, the bladder 12 is inflated using fluid pressure causing the assembly 13 to expand outward toward the inside wall of the pipe 11. The semi-rigid member 28 provides a gap or pathway between the liner 10 and the inner wall of the pipe 11. Any air trapped between the liner 10 and the pipe 11 wall can travel along the pathway created by the semi-rigid member 28 to an end of the liner 10. In this manner, large pockets of fluid (liquid or air) cannot not get trapped between the liner and the pipe 11 and the liner 10 is able to expand all the way outward to the pipe 11 wall, even at bends or curves in the pipe 11.

Embodiments where the semi-rigid member 28 is wound around the liner 10 in a helical configuration help with the positioning of the assembly 13 in the pipe 11. One common place for air to get trapped in a pipe as at the outer curve of a bend. Aligning the assembly in the pipe 10 so the semi-rigid member 28 is properly positioned along the outer surface of the curve can be difficult when the semi-rigid member 28 extends longitudinally along the outer surface of the liner 10. Winding the semi-rigid member 28 around the liner helps ensure that at least some portion of the semi-rigid member 28 will be properly positioned at the bend upon inflation of the assembly to help create a pathway for escaping fluid.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is as follows:

1. A sleeve for use with a repair assembly for repairing a pipeline, said sleeve comprising: a first portion with a first modulus of elasticity and a second portion having a relief area with a second modulus of elasticity that is less than the first modulus of elasticity.

2. The sleeve of claim 1 wherein the first portion is a first material and the relief area is a second material having the second modulus of elasticity.

3. The sleeve of claim 1 wherein the first portion has a first thickness and the relief area has a second thickness, the second thickness less than the first thickness to cause the reduced modulus of elasticity.

4. The sleeve of claim 1 wherein the relief area has one or more openings to cause the reduced modulus of elasticity.

5. The sleeve of claim 1 further comprising a third portion having the first modulus of elasticity, and the relief area between the first portion and the third portion.

6. A repair assembly for repairing a pipeline, the repair assembly comprising:
a bladder;
a liner at least partially surrounding the bladder, the liner configured to be impregnated with a resin capable of curing and hardening;
a sleeve positioned between the liner and the bladder, the sleeve having a first portion with a first modulus of elasticity and a second portion having a relief area with a second modulus of elasticity that is less than the first modulus of elasticity.

7. The repair assembly of claim 6 wherein the bladder and the sleeve are made from a light-permeable material.

8. The repair assembly of claim 6 further comprising a lighting assembly positioned within the bladder.

9. The repair assembly of claim 6 wherein the first portion is a first material and the relief area is a second material having the second modulus of elasticity.

10. The repair assembly of claim 6 wherein the first portion has a first thickness and the relief area has a second thickness, the second thickness is less than the first thickness to cause the reduced modulus of elasticity.

11. The repair assembly of claim 6 wherein the relief area has one or more openings to cause the reduced modulus of elasticity.

12. The repair assembly of claim 6 wherein the sleeve has a circumference, and the relief area is a plurality of openings around the circumference of the sleeve.

13. The repair assembly of claim 6 wherein the liner has a length and the relief area has a length, and the length of the liner is about the same as the length of the relief area.

14. The sleeve of claim 6 further comprising a third portion having the first modulus of elasticity, and the relief area between the first portion and the third portion.

15. The repair assembly of claim 6 wherein the bladder is part of a packer.

16. A method of repairing a pipeline, said method comprising:
taking a repair assembly having a resin impregnable liner, an inflatable bladder, and a sleeve, wherein the sleeve has a first portion with a first modulus of elasticity and a second portion having a relief area with a second modulus of elasticity that is less than the first modulus of elasticity;
positioning the sleeve at least partially around the bladder;
impregnating the liner with a resin capable of curing and hardening;
positioning the liner at least partially around the sleeve;
positioning the repair assembly in the pipeline;
inflating the bladder using fluid pressure to cause the repair assembly to expand outward toward the pipeline along the relief area of the sleeve, then continuing to inflate the bladder using fluid pressure to cause the repair assembly to expand outward toward the pipeline along the second portion of the sleeve;
removing the packer, bladder, and sleeve from the pipeline after the liner has cured and hardened.

17. The method of claim 16 further comprising positioning the repair assembly in the pipeline so the relief area is positioned within a bend in the pipeline.

18. The method of claim 16 wherein the repair assembly further comprises a lighting assembly at least partially within the bladder, and the method further comprises activating the lighting assembly to begin curing the resin.

19. A repair assembly for repairing a pipeline, the repair assembly comprising:
a bladder;
a liner at least partially surrounding the bladder, the liner configured to be impregnated with a resin capable of curing and hardening, wherein the liner has an outer surface configured to be positioned adjacent to the pipeline;
a semi-rigid member positioned along the outer surface of the liner.

20. The repair assembly of claim 19 wherein the semi-rigid member is wrapped around the outer surface of the liner in a helical configuration.

21. The repair assembly of claim 19 wherein the semi-rigid member is an O-ring.

22. The repair assembly of claim 19 wherein the semi-rigid member is an “X” shaped O-ring.

23. The repair assembly of claim 19 wherein the bladder is part of a packer.

24. The repair assembly of claim 19 wherein the liner has an end, and the semi-rigid member extends to the end of the liner.

25. A method of repairing a pipeline, said method comprising:
taking a repair assembly having an inflatable bladder and resin impregnable liner, wherein the liner has an outer surface configured to be positioned adjacent to the pipeline;
positioning the liner at least partially around the bladder;
impregnating the liner with a resin capable of curing and hardening;
wrapping a semi-rigid member around the outer surface of the liner;
positioning the repair assembly in the pipeline;
inflating the bladder using fluid pressure causing the repair assembly to expand outwardly toward the inside wall of the pipeline;
removing the bladder from the pipeline after the liner has cured and hardened.

26. The method of claim 25 wherein the step of wrapping the semi-rigid member around the outer surface of the liner includes wrapping the semi-rigid member around the outer surface of the liner in a helical configuration.

27. The method of claim 25 wherein the liner has an end and the semi-rigid member provides a pathway between the liner and the pipeline allowing any air trapped between the liner and the pipeline to travel along the pathway to the end of the liner.

28. The method of claim 25 further comprising positioning the repair assembly within a bend in the pipeline.
